(19) United States
(12) Patent Application Publication
(10) Pub. No.: US 2025/0074072 A1
(43) Pub. Date: Mar. 6, 2025

(54) Portable Printing Device for Printing Images Stored in Mobile Devices

(71) Applicant: Vincent Patrick, Pennsgrove, NJ (US)

(72) Inventor: Vincent Patrick, Pennsgrove, NJ (US)

(21) Appl. No.: 18/810,643

(22) Filed: Aug. 21, 2024

Related U.S. Application Data
(60) Provisional application No. 63/579,667, filed on Aug. 30, 2023.

(51) Int. Cl. B41J 3/36; B41J 13/10; B41J 29/13; H04M 1/21

(52) U.S. Cl. CPC B41J 3/36; B41J 13/10; B41J 29/13; H04M 1/21

(57) ABSTRACT

A mobile phone picture developer device is disclosed. The device features a planar body with adjustable arms for secure attachment to the rear surface of a mobile phone. It includes a printing head for applying ink or heat to blank photo paper stored in an internal compartment, and a picture dispenser slot for outputting printed images. The device supports both wired and wireless connections via a connection port and a wireless communication module, respectively. Powered by an internal rechargeable battery, the device is activated by a power button and includes a visual indicator for battery status. A corresponding software application installed on the mobile phone facilitates image selection and printing of images. The device provides a convenient and portable solution for instant photo printing directly from mobile phones.

### CROSS-REFERENCE TO RELATED APPLICATION

The present application claims priority to, and the benefit of, U.S. Provisional Application No. 63/579,667, which was filed on Aug. 30, 2023, and is incorporated herein by reference in its entirety.

### FIELD OF THE INVENTION

The present invention generally relates to the field of printing devices. More specifically, the present invention relates to a novel mobile phone picture developer device. The device is attached to the rear surface of a mobile phone. The device includes a printing head for applying ink or heat to blank photo paper stored in an internal compartment, and a picture dispenser slot for outputting printed images. The device supports both wired and wireless connections via a connection port and a wireless communication module, respectively. A corresponding software application installed on the mobile phone facilitates image selection and printing using the device. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals frequently use their smartphones or digital cameras to capture photos, which are then stored locally on these devices or uploaded to cloud storage. Accessing these digital photos generally require digital devices. However, developing these digital photos into physical prints requires significant effort and can be a frustrating process, particularly for those who are not technologically savvy. The steps involved in transferring photos from a phone or digital camera to a printer can be cumbersome and time-consuming.

Moreover, digital cameras are used to click photographs at events and gatherings. However, the inability to print photos instantly at events or gatherings using such devices means individuals often have to wait to receive their printed pictures. The delay diminishes the immediate joy and satisfaction of looking at printed pictures. Additionally, individuals like to have printed photos for personalizing their living areas, office spaces, and other environments. However, the process to obtain printed pictures remains inconvenient and inaccessible for many. Accordingly, there is a need for a portable, user-friendly device that enables for instant photo printing directly from mobile phones.

Therefore, there exists a long felt need in the art for a portable, user-friendly device that enables for instant photo printing directly of images stored in mobile phones. There is also a long felt need in the art for a printing device that instantly prints selected images stored in a mobile device. Additionally, there is a long felt need in the art for a special user-friendly device that enables for instant photo printing directly from mobile phones, eliminating the complexities and delays associated with traditional photo printing methods. Moreover, there is a long felt need in the art for a uniquely designed handheld mobile phone picture developer device that simplifies the process of printing photos captured by a handheld device such as a mobile device, tablet, and more. Further, there is a long felt need in the art for a versatile and user-friendly device that enhances the mobile photography experience by enabling instant photo printing directly from a mobile phone. Furthermore, there is a long felt need in the art for a portable photo printer that enables users to print photos directly from their mobile phone. Finally, there is a long felt need in the art for a uniquely designed printing device that obviates individuals from having to wait to print out their photos or be forced to take the phone or tablet to a professional for printing.

The subject matter disclosed and claimed herein, in one embodiment thereof, comprises a printing device for printing images captured by a mobile device. The device comprises a planar body adapted to adhere to the rear surface of a mobile phone, a pair of adjustable arms are integrated into the opposite side edges of the planar body for securing the device to the mobile phone. A printing head is disposed within the planar body for applying ink or heat to a blank photo paper to print an image, a blank photo paper compartment is operatively coupled to the printing head for holding blank photo papers, a picture dispenser slot is disposed on an edge of the planar body for dispensing a printed image, a connection port is disposed in the planar body for making a wired connection between the device and the mobile phone, a wireless communication module is disposed within the planar body for wirelessly coupling the device to the mobile phone, and an internal battery is disposed within the planar body for providing power to the device. The device communicates with an application for receiving a print command for printing an image selected on the mobile phone.

In this manner, printing device of the present invention accomplishes all of the forgoing objectives and provides users with a novel portable photo printer that enables users to print photos directly from their mobile phone. The device can connect to a mobile phone and an image selected on the mobile phone can be instantly printed using the printer. The device prevents individuals from having to wait to print out their photos or be forced to take the phone or tablet to a professional for printing.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a mobile phone picture developer device. The device is configured to print images stored in a mobile device and comprises a planar body adapted to adhere to the rear surface of a mobile phone, a pair of adjustable arms are integrated into the opposite side edges of the planar body for securing the device to the mobile phone. A printing head is disposed within the planar body for applying ink or heat to a blank photo paper to print an image, a blank photo paper compartment is operatively coupled to the printing head for holding blank photo papers, a picture dispenser slot is disposed on an edge of the planar body for dispensing a printed image, a connection port is disposed in the planar body for making a wired connection between the device and the mobile phone, a wireless communication module is disposed within the planar body for wirelessly coupling the device to the mobile phone, and an internal battery is disposed within the planar body for providing power to the device.

In yet another embodiment, a mobile phone picture developer system is disclosed. The system includes a mobile phone picture developer device comprising a planar body adapted to adhere to the rear surface of a mobile phone, a pair of adjustable arms are integrated into the opposite side edges of the planar body for securing the device to the mobile phone, a connection port disposed in the planar body for making a wired connection between the device and the mobile phone, a wireless communication module disposed within the planar body for wirelessly coupling the device to the mobile phone, and a power button for activating the device. The system also includes a software application installed on the mobile phone, the software application configured to establish a connection between the mobile phone and the device via the connection port or the wireless communication module, display an interface on the mobile phone for selecting an image to print, and send a print command to the mobile phone picture developer device to print the selected image.

In another embodiment, a method for printing photos using a mobile phone picture developer device is described. The method includes the steps of detachably attaching the mobile phone picture developer device to the rear surface of a mobile phone using adjustable arms, activating the device by powering it on, establishing a connection between the device and the mobile phone via a wired connection or a wireless communication module, selecting an image for printing using an interface displayed on the mobile phone, and printing the selected image in real-time, wherein the printed image is dispensed from a picture dispenser slot of the device.

In another aspect, a mobile phone picture developer device for instant photo printing is disclosed. The device includes a planar body having an inner panel and an exterior panel, the planar body adapted to adhere to the rear surface of a mobile phone, a pair of adjustable arms integrated into the opposite side edges of the planar body for securing the device to the mobile phone, the arms adapted to be stretched or adjusted (i.e., elastic) in opposite directions and return to their original positions, a transverse wall extends along the bottom edge of the inner panel to support the mobile phone, a visual indicator on the exterior panel for indicating battery status, a picture dispenser slot on the bottom edge for dispensing printed images, a printing head for applying ink or heat to blank photo paper, and a blank photo paper compartment for holding blank photo papers.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of mobile phone picture developer device of the present invention in accordance with the disclosed structure;

FIG. 2 illustrates a front perspective of the mobile phone picture developer device of the present invention in accordance with the disclosed structure;

FIG. 3 illustrates a block diagram depicting different internal components included in the instant photo printing device of the present invention in accordance with the disclosed structure;

FIG. 4 illustrates a perspective view showing the instant printing device of the present invention being adhered to a mobile device in accordance with the disclosed structure;

FIG. 5 illustrates a perspective view showing the printing device being used for printing an image stored in the mobile device in accordance with the disclosed structure;

FIG. 6 illustrates a perspective view showing a user printing an image using the printing device in accordance with the disclosed structure; and

FIG. 7 illustrates a flow chart depicting a process of use of the mobile phone picture developer device of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a portable, user-friendly device that enables for instant photo printing directly of images stored in mobile phones. There is also a long felt need in the art for a printing device that instantly prints selected images stored in a mobile device. Additionally, there is a long felt need in the art for a special user-friendly device that enables for instant photo printing directly from mobile phones, eliminating the complexities and delays associated with traditional photo printing methods. Moreover, there is a long felt need in the art for a uniquely designed handheld mobile phone picture developer device that simplifies the process of printing photos captured by a handheld device such as a mobile device, tablet, and more. Further, there is a long felt need in the art for a versatile and user-friendly device that enhances the mobile photography experience by enabling instant photo printing directly from a mobile phone. Furthermore, there is a long felt need in the art for a portable photo printer that enables users to print photos directly from their mobile phone. Finally, there is a long felt need in the art for a uniquely designed printing device that prevents individuals from having to wait to print out their photos or be forced to take the phone or tablet to a professional for printing.

The present invention, in one exemplary embodiment, is a method for printing photos using a mobile phone picture developer device. The method includes the steps of detachably attaching the mobile phone picture developer device to the rear surface of a mobile phone using adjustable arms, activating the device by powering it on, establishing a connection between the device and the mobile phone via a wired connection or a wireless communication module, selecting an image for printing using an interface displayed on the mobile phone, and printing the selected image in real-time, wherein the printed image is dispensed from a picture dispenser slot of the device.

Reference will now be made in detail to the present preferred embodiments of the invention, examples of which are illustrated in the accompanying drawings. Wherever possible, the same reference numerals are used in the drawings and the description to refer to the same or like parts.

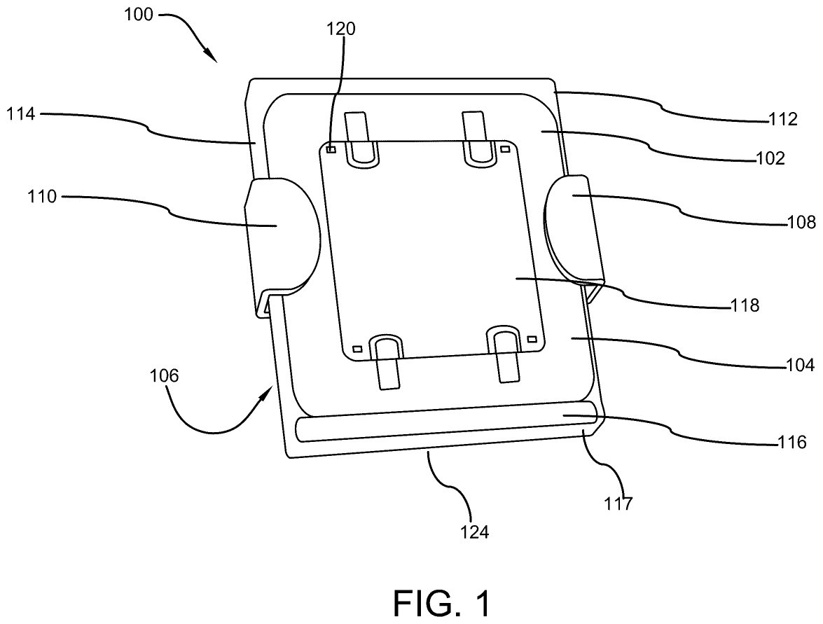

Referring initially to the drawings, FIG. 1 illustrates a perspective view of mobile phone picture developer device of the present invention in accordance with the disclosed structure. The mobile phone picture developer device 100 of the present invention is designed as a compact, portable photo printer that enables users to print photos directly from their mobile phones. The device 100 is compact and handheld, making it easy to use and carry the device 100 everywhere. More specifically, the mobile phone picture developer device 100 includes a planar body 102 which is generally rectangular or square (i.e., rectilinear) to adhere to the rear surface of a mobile phone. The planar body 102 includes an inner panel 104 and an exterior panel 106. A pair of adjustable arms 108, 110 are integrated to the opposite side edges 112, 114 respectively. The arms 108, 110 are adapted to be stretched or adjusted (i.e., clastic) in opposite directions enabling the device 100 to fit to a mobile phone and the arms 108, 110 retain (i.e., revert or spring back to) their original relaxed length or spacing when not pulled by the user.

A transverse wall 116 extends along the bottom edge 117 of the inner panel 104. The transverse wall 116 extends horizontally in a plane perpendicular to the inner panel 104 and is adapted to support the mobile phone to which the device 100 is adhered as illustrated later in the disclosure. A detachable cover 118 is disposed on the inner panel 104 for covering and securing the internal components of the mobile phone picture developer device 100. The detachable cover 118 is fastened using a plurality of fasteners 120 and can be removed to access the internal components of the device 100.

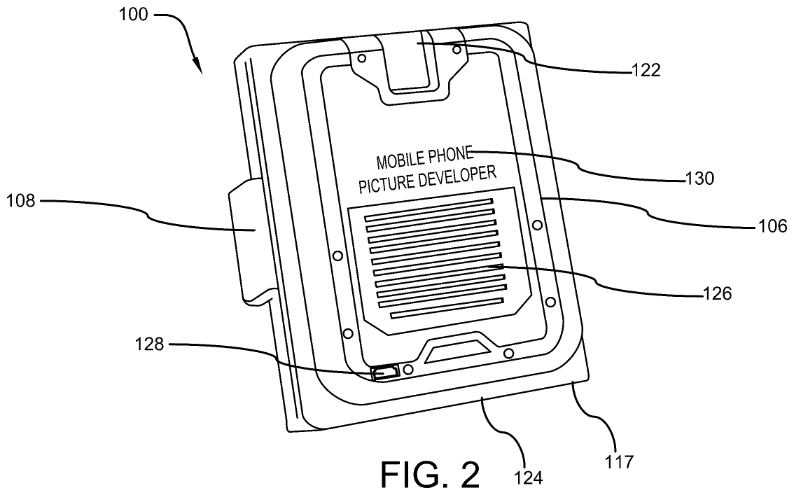

FIG. 2 illustrates a front perspective of the mobile phone picture developer device of the present invention in accordance with the disclosed structure. The exterior panel 106 of the mobile phone picture developer device 100 includes a visual indicator 122 for indicating battery status of the device 100. A picture dispenser slot 124 is disposed on the bottom edge 117 for dispensing a physical printed image from the device 100. The planar body 102 includes a printing head 126 which can be a thermal printing head or inkjet for applying ink or heat to a blank photo paper to print the image.

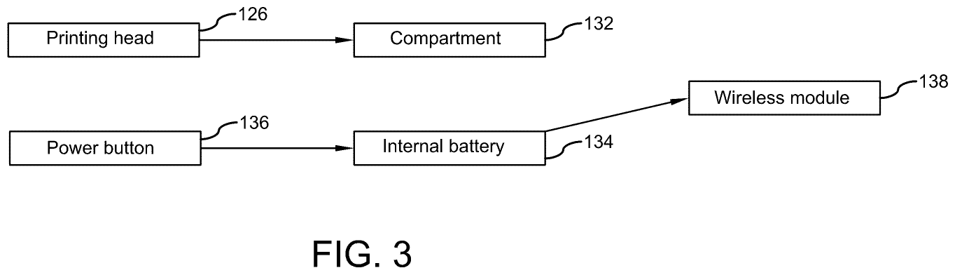

A connection port 128 which is preferably a USB port or can be any connection port is disposed in the planar body 102. The connection port 128 is used for making a wired connection between the printer device 100 and a mobile phone. In some embodiments, the printer device 100 includes a wireless communication module (FIG. 3) for wirelessly coupling the device 100 and a mobile phone.

It will be apparent to a person skilled in the art that the printer device 100 is detachably attached to a mobile phone using the adjustable arms 108, 110 and is used for instant photo printing for printing photos stored in a mobile phone. The printer device 100 enables users to print photos directly from their phones to use in scrapbooks or photo albums. The device 100 can be designed for different mobile phones and can be made in different colors and designs. The device 100 is preferably made of plastic and the exterior panel 106 can include a logo or indicium 130 for branding and marketing purposes.

FIG. 3 illustrates a block diagram depicting different internal components included in the instant photo printing device of the present invention in accordance with the disclosed structure. As illustrated, the printer device 100 includes the printing head 126 which is configured to apply ink or heat to a blank photo paper to print an image selected by a user on the coupled mobile phone. The device 100 can use different printing technologies such as inkjet or thermal printing and depending on the printing technology, the printing head 126 is disposed in the device 100.

The printing head 126 is operatively coupled to a blank photo paper compartment 132. The blank photo paper compartment 132 is designed to hold a stack of blank photo papers and a single blank photo paper is used in one instance for printing an image. In some embodiments, the detachable cover 118 can be removed to refill the compartment 132 with the stack of blank photo papers.

An internal battery 134 is disposed in the device 100 for providing electric power for operation of the device 100. The internal battery 134 is replaceable and can be removed for recharging. In the preferred embodiment, the internal battery 134 is Li-Ion battery and is disposed in the body 102. A power button 136 when activated enables the battery 134 to provide the electric power to the device 100 and helps in printing images on blank papers. The wireless communication module 138 establishes preferably a Bluetooth channel between the device 100 and a mobile phone. The Bluetooth channel enables a user to wirelessly transmit an image from the mobile phone to the device 100 for printing on the blank photo paper. In other embodiments, different types of other communication channels such as Wi-Fi, Wi-Fi Direct, and more can be established by the wireless communication channel.

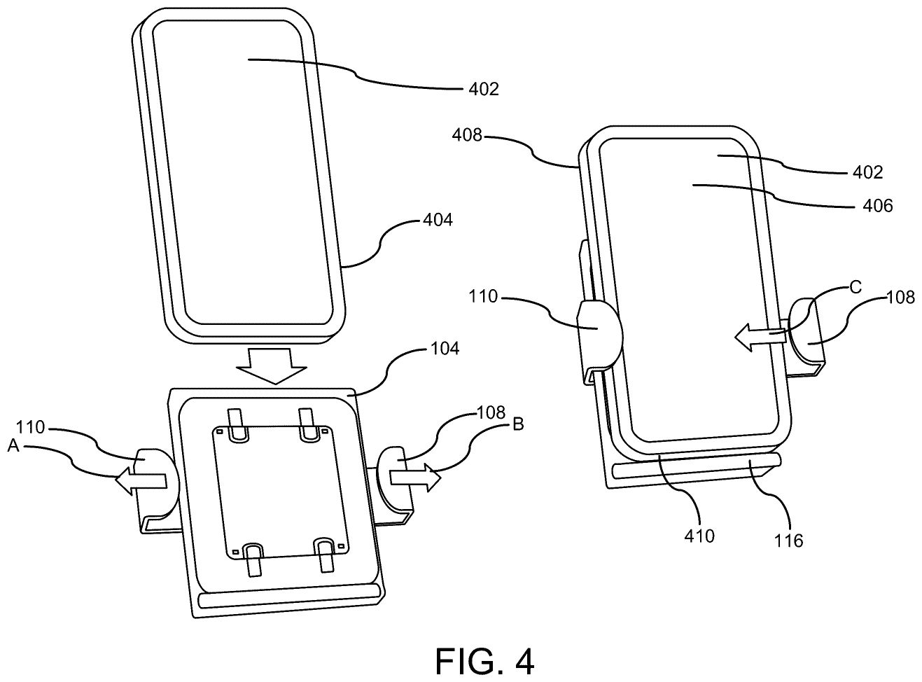

FIG. 4 illustrates a perspective view showing the instant printing device of the present invention being adhered to a mobile device in accordance with the disclosed structure. As illustrated, for adhering the device 100 to the mobile device 402, the device 100 is positioned such that the inner surface or panel 104 adheres to the rear surface 404 of the mobile device 402. The adjustable arms 108, 110 are pulled apart (i.e., movement represented by Arrow A and Arrow B) to accommodate the mobile device 402 therebetween and then the arms 108, 110 are released (Arrow C). The elastic nature of the adjustable arms 108, 110 enable them to retain (i.e., revert or spring back to) their original relaxed length or spacing and the arms 108, 110 abut the opposite side edges 406, 408 of the mobile phone 402. The device 100 is positioned such that the transverse wall 116 supports the bottom edge 410 of the phone 402, thereby eliminating the phone 402 from slipping longitudinally. The arms 108, 110 can be pulled apart again to remove the mobile device 402 from the printing device 100.

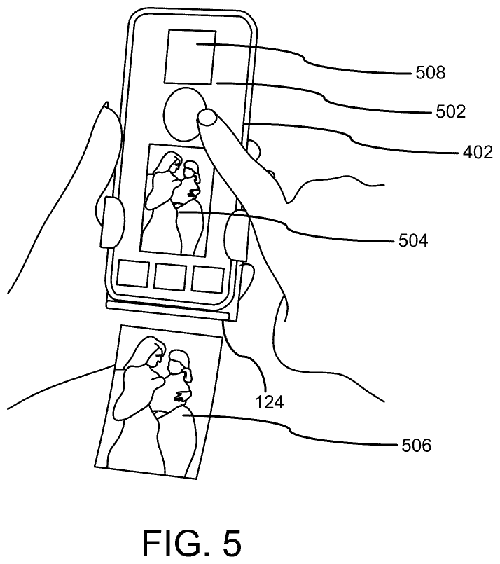

FIG. 5 illustrates a perspective view showing the printing device being used for printing an image stored in the mobile device in accordance with the disclosed structure. When the printing device 100 is adhered to the mobile device 402 and is activated, a corresponding interface 502 is displayed on the mobile device 402. The interface 502 enables a wireless connection to be established between the printing device 100 and the mobile device 402. The interface 502 also enables selection of an image 504 for printing using the printing device 100. A printed image 506 of the selected image is dispensed from the picture dispenser slot 124. It will be apparent to a person skilled in the art that the interface 502 can be displayed by a software application 508 installed in the mobile device 402.

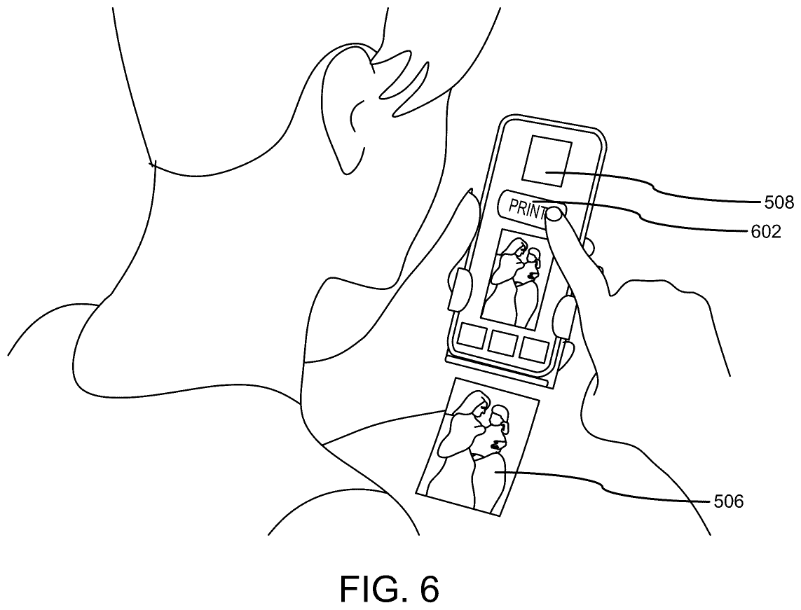

FIG. 6 illustrates a perspective view showing a user printing an image using the printing device in accordance with the disclosed structure. As illustrated, a PRINT option 602 is provided to the user by the application 508 and when the PRINT option 602 is selected, a wireless instruction is sent to the device 100 for printing the selected image. The printed image can have different pixel resolutions and may support different image resolutions of the mobile device.

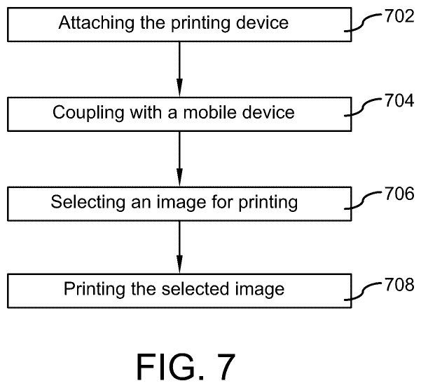

FIG. 7 illustrates a flow chart depicting a process of use of the mobile phone picture developer device of the present invention in accordance with the disclosed structure. Initially, the device 100 is detachably attached to a mobile device on the rear surface of the mobile device (Step 702). Then, the device 100 is activated and coupled to the mobile device using a wireless channel or alternatively through a wired medium (Step 704). Thereafter, an image is selected using an interface displayed on the mobile device for printing (Step 706). Finally, using the print option, the selected image is printed in real-time and is dispensed from the picture dispenser slot 124 (Step 708).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “mobile phone picture developer device”, “printing device”, “instant printing device”, “device”, and “instant photo printing device” are interchangeable and refer to the mobile phone picture printing device 100 of the present invention.

Notwithstanding the forgoing, the mobile phone picture printing device 100 of the present invention can be of any suitable size and configuration as is known in the art without affecting the overall concept of the invention, provided that it accomplishes the above stated objectives. One of ordinary skill in the art will appreciate that the mobile phone picture printing device 100 as shown in the FIGS. are for illustrative purposes only, and that many other sizes and shapes of the mobile phone picture printing device 100 are well within the scope of the present disclosure. Although the dimensions of the mobile phone picture printing device 100 are important design parameters for user convenience, the mobile phone picture printing device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A mobile phone picture developer device comprising:
a planar body for adhering to a rear surface of a mobile phone, wherein said planar body having an inner panel and an outer panel;
a pair of adjustable arms integrated to opposing side edges of said planar body for selectively attaching a mobile phone picture developer device to a mobile phone;
a transverse wall extending along a bottom edge of said inner panel;
a picture dispenser slot disposed on said bottom edge for dispensing a physical printed image from said mobile phone picture developer device;
wherein said planar body having a printing head;
wherein said printing head is selected from the group consisting of a thermal printing head and an inkjet;
wherein said planar body is rectilinear to adhere to a rear surface of the mobile phone;
wherein each one of said pair of adjustable arms is elastic;
wherein each one of said pair of adjustable arms springs back to an original relaxed length when removed from said opposing side edges of said planar body;
wherein said transverse wall extending horizontally in a plane perpendicular to said inner panel to support the mobile phone to which said mobile phone picture developer device is adhered; and
further wherein said printing head operatively coupled to a blank photo paper compartment, wherein said blank photo paper compartment holding a stack of blank photo papers.

2. The mobile phone picture developer device of claim 1 further comprising a detachable cover disposed on said inner panel for covering said mobile phone picture developer device.

3. The mobile phone picture developer device of claim 2, wherein said detachable cover having a plurality of selectively removable fasteners.

4. The mobile phone picture developer device of claim 1, wherein said exterior panel having a visual indicator for indicating a battery status of said mobile phone picture developer device.

5. The mobile phone picture developer device of claim 2, wherein said planar body having a wired connection between the mobile phone and said mobile phone picture developer device.

6. The mobile phone picture developer device of claim 2 further comprising a wireless connection between the mobile phone and said mobile phone picture developer device.

7. The mobile phone picture developer device of claim 2, wherein said printing head applies ink to a blank photo paper to print an image selected by a user from the mobile phone.

8. The mobile phone picture developer device of claim 7, wherein said mobile phone picture developer device having a battery for providing electric power for operation of said mobile phone picture developer device.

9. The mobile phone picture developer device of claim 8, wherein said battery is rechargeable.

10. The mobile phone picture developer device of claim 6, wherein said wireless connection selected from the group consisting of a Bluetooth channel, a Wi-Fi, and a Wi-Fi Direct.

11. The mobile phone picture developer device of claim 1, wherein said inner panel adheres to a rear surface of the mobile device.

12. A mobile phone picture developer device comprising:
a planar body for adhering to a rear surface of a mobile phone, wherein said planar body having an inner panel and an outer panel;
a pair of adjustable arms integrated to opposing side edges of said planar body for selectively attaching a mobile phone picture developer device to a mobile phone;
a transverse wall extending along a bottom edge of said inner panel;
a picture dispenser slot disposed on said bottom edge for dispensing a physical printed image from said mobile phone picture developer device;
wherein said planar body having a printing head;
wherein said printing head is selected from the group consisting of a thermal printing head and an inkjet;
wherein said planar body is rectilinear to adhere to a rear surface of the mobile phone;
wherein each one of said pair of adjustable arms is adjustable in length;
wherein each one of said pair of adjustable arms springs back to an original relaxed length when removed from said opposing side edges of said planar body;
wherein said transverse wall extending horizontally in a plane perpendicular to said inner panel to support the mobile phone to which said mobile phone picture developer device is adhered;
wherein said printing head operatively coupled to a blank photo paper compartment, wherein said blank photo paper compartment holding a stack of blank photo papers; and
further comprising a wireless connection between the mobile phone and said mobile phone picture developer device.

13. The mobile phone picture developer device of claim 12 further comprising a detachable cover disposed on said inner panel for covering said mobile phone picture developer device.

14. The mobile phone picture developer device of claim 13, wherein said detachable cover having a plurality of selectively removable fasteners.

15. The mobile phone picture developer device of claim 14, wherein said exterior panel having a visual indicator for indicating a battery status of said mobile phone picture developer device.

16. The mobile phone picture developer device of claim 15, wherein said printing head applies ink to a blank photo paper to print an image selected by a user from the mobile phone.

17. The mobile phone picture developer device of claim 16, wherein said mobile phone picture developer device having a battery for providing electric power for operation of said mobile phone picture developer device.

18. A method of developing a picture from a mobile phone, the method comprising the steps of:
providing a planar body for adhering to a rear surface of a mobile phone, wherein said planar body having an inner panel and an outer panel, a pair of adjustable arms integrated to opposing side edges of said planar body for selectively attaching a mobile phone picture developer device to a mobile phone, a transverse wall extending along a bottom edge of said inner panel, a picture dispenser slot disposed on said bottom edge for dispensing a physical printed image from said mobile phone picture developer device, wherein said planar body having an inner panel and an outer panel, further wherein said planar body having a printing head;
adhering said planar body to a rear surface of the mobile phone;
adjusting a length of each one of said pair of adjustable arms to secure said each one of said pair of adjustable arms to opposing edges of the mobile phone;
springing back each one of said pair of adjustable arms to an original relaxed length when removed from said opposing edges of the mobile phone;
extending horizontally said transverse wall in a plane perpendicular to said inner panel to support the mobile phone to which said mobile phone picture developer device is adhered;
operatively coupling said printing head to a blank photo paper compartment, wherein said blank photo paper compartment holding a stack of blank photo papers;
wirelessly connecting the mobile phone and said mobile phone picture developer device;
selecting an image from the mobile phone to transmit to said mobile phone picture developer device; and
printing said image from said mobile phone picture developer device.

19. The method of developing a picture from a mobile phone of claim 18 further comprising a detachable cover disposed on said inner panel for covering said mobile phone picture developer device, wherein said detachable cover having a plurality of selectively removable fasteners.

20. The method of developing a picture from a mobile phone of claim 18, wherein said printing head applies ink to a blank photo paper to print said image selected by a user from the mobile phone.
